(19) United States
(12) Patent Application Publication
(10) Pub. No.: US 2021/0012649 A1
(43) Pub. Date: Jan. 14, 2021

(54) INFORMATION PROCESSING APPARATUS, ROAD ANALYSIS METHOD, AND NON-TRANSITORY COMPUTER READABLE MEDIUM STORING PROGRAM

(71) Applicant: NEC Corporation, Tokyo (JP)

(72) Inventor: Michihiko YUSA, Tokyo (JP)

(73) Assignee: NEC Corporation, Tokyo (JP)

(21) Appl. No.: 17/042,422

(22) PCT Filed: Oct. 30, 2018
(86) PCT No.: PCT/JP2018/040292

§ 371 Date: Sep. 28, 2020

(30) Foreign Application Priority Data
Mar. 29, 2018 (JP) 2018-066016

(51) Int. Cl. G08G 1/01; G06Q 50/26; G08G 1/052; G06K 9/00

(52) U.S. Cl. CPC G08G 1/0129; G08G 1/0137; G06K 2209/23; G08G 1/052; G06K 9/00785; G06Q 50/26

(57) ABSTRACT

The present disclosure provides an information processing apparatus, a road analysis method, and a program that are capable of creating information useful for improving traffic infrastructure. An information processing apparatus (1) includes: a camera video image acquisition unit (2) configured to acquire video image data from a camera configured to continuously shoot a traffic state of a predetermined road; an analysis unit (3) configured to generate statistical information about traffic on the road from the video image data acquired by the camera video image acquisition unit (2); and a disadvantage calculation unit (4) configured to calculate a degree of a disadvantage caused by a traffic congestion on the road by using the statistical information generated by the analysis unit (3).

### TECHNICAL FIELD

The present disclosure relates to an information processing apparatus, a road analysis method, and a program.

### BACKGROUND ART

Traffic congestion has become a social problem in many countries. In order to eliminate traffic congestion, a radical improvement in traffic infrastructure is required. Patent Literature 1 is a document related to this. Patent Literature 1 discloses that a system calculates a congestion loss amount based on a congestion loss time, a traffic volume, and a time value in order to utilize the congestion loss amount for road administration such as road expansion work.

### CITATION LIST

### Patent Literature

### Patent Literature 1: Japanese Unexamined Patent Application Publication No. 2003-281685

### SUMMARY OF INVENTION

### Technical Problem

In Patent Literature 1, travel time obtained by a probe car, and traffic volume, which is the result of a survey conducted by the Ministry of Land, Infrastructure, Transport and Tourism, are used for calculation of the congestion loss amount. Thus, in the first place, the technique disclosed in Patent Literature 1 cannot calculate the congestion loss amount for a road on which the probe car has not traveled. Further, even if the probe car travels on a road for which the congestion loss amount is to be calculated, it is difficult to accurately evaluate the road, because the number of samples of data to be acquired depends on the number of probe cars and thus the sufficient number of samples may not be acquired. Further, as the traffic volume used for calculation of the congestion loss amount is the result of a survey conducted by the Ministry of Land, Infrastructure, Transport and Tourism, it is impossible to calculate the congestion loss amount for a road for which there is no result of the above survey. Accordingly, the system disclosed in Patent Literature 1 is not sufficiently useful for road administration.

Therefore, one of the objects to be attained by an example embodiment disclosed herein is to provide an information processing apparatus, a road analysis method, and a program that are capable of creating information useful for improving traffic infrastructure.

### Solution to Problem

An information processing apparatus according to a first aspect includes: camera video image acquisition means for acquiring video image data from a camera configured to continuously shoot a traffic state of a predetermined road; analysis means for generating statistical information about traffic on the road from the video image data acquired by the camera video image acquisition means; and disadvantage calculation means for calculating a degree of a disadvantage caused by a traffic congestion on the road by using the statistical information generated by the analysis means.

A road analysis method according to a second aspect includes causing an information processing apparatus to: acquire video image data from a camera configured to continuously shoot a traffic state of a predetermined road; generate statistical information about traffic on the road from the acquired video image data; and calculate a degree of a disadvantage caused by a traffic congestion on the road by using the statistical information.

A program according to a third aspect causes a computer to execute: a camera video image acquisition step of acquiring video image data from a camera configured to continuously shoot a traffic state of a predetermined road; an analysis step of generating statistical information about traffic on the road from the video image data acquired in the camera video image acquisition step; and disadvantage calculation step of calculating a degree of a disadvantage caused by a traffic congestion on the road by using the statistical information generated in the analysis step.

### Advantageous Effects of Invention

According to the above-described aspects, it is possible to provide an information processing apparatus, a road analysis method, and a program that are capable of creating information useful for improving traffic infrastructure.

### BRIEF DESCRIPTION OF DRAWINGS

FIG. 1 is a block diagram showing an example of a configuration of an information processing apparatus according to an outline of an example embodiment;

FIG. 2 is a block diagram showing an example of a configuration of an information processing system according to the example embodiment;

FIG. 3 is a schematic diagram showing a series of traffic-congested sections;

FIG. 4 is a flowchart showing an example of an operation of a server; and

FIG. 5 is a block diagram showing an example of a hardware configuration of the server.

### DESCRIPTION OF EMBODIMENTS

### <Outline of Example Embodiment>

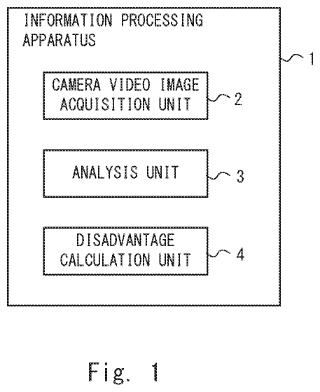

Prior to describing an example embodiment in detail, an outline of the example embodiment is given. FIG. 1 is a block diagram showing an example of a configuration of an information processing apparatus 1 according to the outline of the example embodiment. As shown in FIG. 1, the information processing apparatus 1 includes a camera video image acquisition unit 2, an analysis unit 3, and a disadvantage calculation unit 4.

The camera video image acquisition unit 2 acquires video image data from a camera (not shown in FIG. 1) that continuously shoots a traffic state of a predetermined road. Although the camera video image acquisition unit 2, for example, acquires video image data transmitted by the camera via a wired or wireless network, it may instead acquire the image data by loading the image data stored in a storage medium. As described above, it is sufficient for the camera video image acquisition unit 2 to acquire image data, and thus any method for acquiring video image data may be employed. As described above, as the camera video image acquisition unit 2 acquires video image data from the camera that continuously shoots a traffic state of a predetermined road, the video image data acquired by the camera video image acquisition unit 2 is the result of a continuous observation of the predetermined road. Note that the above camera is, for example, a camera permanently installed on the periphery of a road to be shot.

The analysis unit 3 generates statistical information about the traffic on the road from the video image data acquired by the camera video image acquisition unit 2. For example, the analysis unit 3 performs image analysis processing on the video image data, and generates a predetermined kind of statistical information such as information indicating a speed of a vehicle or a traffic volume. Note that the statistical information generated by the analysis unit 3 is not limited to a specific kind of statistical information and may be any statistical information about the traffic on the road which can be generated from the video image data acquired by the camera video image acquisition unit 2.

The disadvantage calculation unit 4 calculates the degree of a disadvantage caused by a traffic congestion on a road by using the statistical information generated by the analysis unit 3. Note that the disadvantage described herein is not limited to a specific type of disadvantage and may be any disadvantage caused by a traffic congestion on a road. For example, the disadvantage may be an economic loss or an environmental disadvantage such as a disadvantage due to carbon dioxide. The degree of the disadvantage caused by a traffic congestion on a road can be used as a criterion for determining the degree of the need for an improvement in traffic infrastructure, such as a widening of the road. Accordingly, the disadvantage calculation unit 4 calculates the degree of the disadvantage more accurately, so that it can be expected that the degree of the need for an improvement in traffic infrastructure will be determined more accurately.

As described above, the information processing apparatus 1 calculates the degree of the disadvantage caused by a traffic congestion on a predetermined road based on statistical information generated from the result of a continuous observation of the predetermined road. That is, according to the information processing apparatus 1, it is possible to calculate, based on statistical information in which the traffic state of the predetermined road is accurately reflected, an effect of the traffic congestion. Accordingly, it is possible to calculate an effect of the traffic congestion more accurately than when it is calculated based on information obtained by a probe car or the like. That is, according to the information processing apparatus 1, it is possible to create information more useful for improving traffic infrastructure.

### <Details of Example Embodiment>

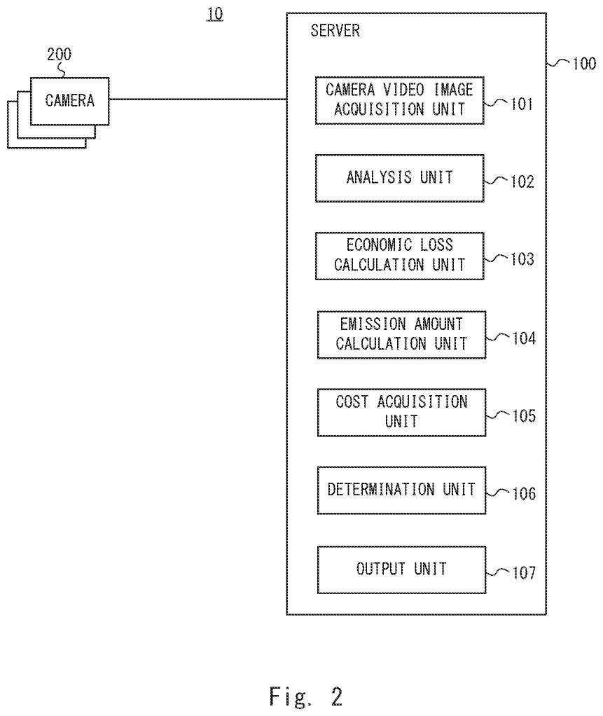

Next, details of the example embodiment are described. FIG. 2 is a block diagram showing an example of a configuration of an information processing system 10 according to the example embodiment. As shown in FIG. 2, the information processing system 10 includes a server 100 and a plurality of cameras 200. Note that the server 100 corresponds to the information processing apparatus 1 shown in FIG. 1.

Each of the cameras 200 is a camera that continuously shoots a traffic state of a predetermined road. In this example embodiment, although each of the cameras 200 is installed so that it shoots a traffic state of each intersection of the road as an example, an object to be shot by the camera 200 is not limited to the intersection. For example, the camera 200 may be provided so that it shoots a traffic state at any point between the intersections. The camera 200 is permanently installed on the periphery of a predetermined place, which is an object to be shot, so that the camera 200 can continuously observe the predetermined place. The camera 200 transmits the shot video image data to the server 100 via a wired or wireless network.

As shown in FIG. 2, the server 100 includes a camera video image acquisition unit 101, an analysis unit 102, an economic loss calculation unit 103, an emission amount calculation unit 104, a cost acquisition unit 105, a determination unit 106, and an output unit 107.

The camera video image acquisition unit 101 corresponds to the camera video image acquisition unit 2 shown in FIG. 1, and acquires video image data from the camera 200. In this example embodiment, the camera video image acquisition unit 101 acquires video image data from each of the cameras 200 via a network.

The analysis unit 102 corresponds to the analysis unit 3 shown in FIG. 1, and generates statistical information about the traffic on the road from the video image data acquired by the camera video image acquisition unit 101 by performing image analysis processing. In this example embodiment, the analysis unit 102 generates, as the statistical information, information indicating the speed of a vehicle traveling on the road, the number of vehicles traveling on the road (i.e., a traffic volume), a waiting time, a traffic-congested time, or the like. Note that the waiting time is a time required for a vehicle to pass through a predetermined section on the road shot in the camera video image. Further, the traffic-congested time is the length of time during which a traffic congestion has continued. The analysis unit 102 generates, for example, statistical information about video image data in a predetermined statistical acquisition period (e.g., one year).

For example, the analysis unit 102 recognizes vehicles from the video image data and analyzes the change in the position of each recognized vehicle in a time series, thereby generating the aforementioned statistical information. More specifically, for example, the analysis unit 102 analyzes the speed of each vehicle detected from the video image data of a predetermined measurement time (e.g., 10 minutes), and calculates the average of these speeds, thereby calculating the average speed of the vehicle during this measurement time. Further, the analysis unit 102 analyzes the number of vehicles detected from the video image data of the predetermined measurement time, thereby calculating the number of vehicles (i.e., the traffic volume) during this measurement time. Further, the analysis unit 102 analyzes the time required for each vehicle detected from the video image data of the predetermined measurement time to pass through a predetermined road section, and calculates the average of these times, thereby calculating the waiting time. Further, the analysis unit 102 detects the occurrence of a traffic congestion from the video image data. In this case, specifically, for example, if the calculated average speed is equal to or less than a predetermined threshold (e.g., 20 kilometers per hour), the analysis unit 102 determines that a traffic congestion has occurred. Note that in the following description, this threshold for determining the occurrence of a traffic congestion is referred to as a traffic congestion speed. Then, the analysis unit 102 sets the length of time of the traffic state in which it is determined that a traffic congestion has continued as the traffic-congested time. Further, the analysis unit 102 may generate statistical information indicating a time period during which a traffic congestion has occurred.

The analysis unit 102 may generate the above statistical information pieces for each lane of the road. Note that the above-described method for an analysis performed by the analysis unit 102 is merely an example, and the analysis unit 102 may generate statistical information pieces by any other methods.

Further, the analysis unit 102 may further generate statistical information about the type of vehicle traveling on the road from the video image data acquired by the camera video image acquisition unit 101. For example, the analysis unit 102 recognizes the type of vehicle traveling on the road from the video image data by pattern matching or the like, thereby generating statistical information about the type of vehicle. For example, the analysis unit 102 generates statistical information about the type of vehicle detected from the video image data of the predetermined measurement time. Note that the method for generating statistical information about the type of vehicle is not limited to the above, and the analysis unit 102 may generate statistical information about the type of vehicle by any other methods.

Further, the analysis unit 102 may generate statistical information about the number of passengers of the vehicle traveling on the road from the video image data acquired by the camera video image acquisition unit 101. For example, the analysis unit 102 may count the number of passengers by recognizing the number of people in the vehicle from the video image data, or may count the number of passengers based on the result of the recognition of the type of vehicle. When the number of passengers is counted by recognizing the type of vehicle, for example, the number of passengers estimated for each type of vehicle is set in advance. The analysis unit 102 may calculate the total number or the average number of passengers of all the vehicles detected from the video image data of the predetermined measurement time. Note that the analysis unit 102 may generate statistical information about the number of passengers by any method other than the one described above.

Each of the economic loss calculation unit 103 and the emission amount calculation unit 104 corresponds to the disadvantage calculation unit 4 shown in FIG. 1. The economic loss calculation unit 103 calculates an amount of economic loss caused by the traffic congestion on the road by using statistical information generated by the analysis unit 102. Further, the emission amount calculation unit 104 calculates an amount of emissions of a predetermined component of an exhaust gas emitted from the vehicle due to the traffic congestion on the road by using the statistical information generated by the analysis unit 102. That is, the emission amount calculation unit 104 calculates the amount of the predetermined component that is excessively emitted due to the traffic congestion. Note that in this example embodiment, to be specific, the predetermined component is carbon dioxide, however it may instead be other harmful components included in the exhaust gas.

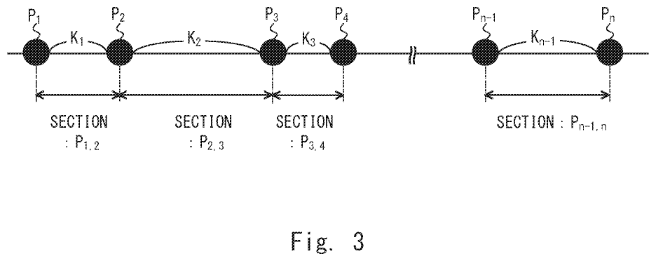

Specific examples of calculations performed by the economic loss calculation unit 103 and the emission amount calculation unit 104 are described below. FIG. 3 is a schematic diagram showing a series of traffic-congested sections. In FIG. 3, P₁, P₂, . . . , Pₙ₋₁, and Pₙ, respectively, are places (i.e., measurement points) to be monitored by the camera 200, and each of them is a place in which it is determined by the analysis unit 102 that a traffic congestion has occurred. That is, the aforementioned average speed of the vehicle obtained from the video image data about a measurement point Pᵢ (where 1≤i≤n) is the traffic congestion speed or lower. Further, P₁, P₂, . . . , Pₙ₋₁, and Pₙ are measurement points that are continuously formed on the road. Note that although P₁, P₂, . . . , Pₙ₋₁, and Pₙ are, for example, intersections, this is merely an example.

It should be noted that as shown in FIG. 3, the section specified by the measurement points Pᵢ and Pᵢ₊₁ is defined as P_{i,i+1}. Further, the distance of the section P_{i,i+1} is defined as Note that the distance Kᵢ is a known distance as it is determined in accordance with the installation place of the camera 200.

In order to explain the specific examples of calculations performed by the economic loss calculation unit 103 and the emission amount calculation unit 104, the following variables are further defined.

Sᵢ: an average speed at the measurement point Pᵢ, that is, the average speed of the vehicle detected from the video image data of a predetermined measurement time obtained by processing performed by the analysis unit 102

Qᵢ: a traffic volume at the measurement point Pᵢ, that is, the number of vehicles detected from the video image data of a predetermined measurement time obtained by processing performed by the analysis unit 102

JR: the number of passengers per vehicle

CO₂: an amount of carbon dioxide emitted from one vehicle per unit time

JT: a time period during which a traffic congestion has occurred

JS: a traffic congestion speed (e.g., 20 kilometers per hour)

M: a predetermined labor unit cost

In this example embodiment, the economic loss calculation unit 103 calculates, as an example, an amount Z₁ of economic loss based on a loss time due to a traffic congestion, the number of vehicles that have caused the loss time, the number of passengers of the vehicles, and the labor unit cost. Specifically, the economic loss calculation unit 103 calculates the amount Z₁ of economic loss, for example, by the following Expression (1).

$$\begin{matrix}[ Expression 1 ] & \\ {Z}_{1} = {\sum }_{{P}_{i , i + 1}} {\sum }_{J T} ( {T}_{loss} \times N \times JR \times M ) & ( 1 )\end{matrix}$$

In the Expression (1), Tₗₒₛₛ represents a loss time. The loss time Tₗₒₛₛ is the difference between a travel time when a vehicle travels the distance Kᵢ of the section P_{i,i+1} at the speed during a traffic congestion and a travel time when a vehicle travels the distance Kᵢ at the traffic congestion speed JS. That is, the loss time Tₗₒₛₛ indicates an extra travel time required due to the traffic congestion. Specifically, the loss time Tₗₒₛₛ is expressed, for example, by the following Expression (2).

$$\begin{matrix}[ Expression 2 ] & \\ {T}_{l o s s} = \frac{{K}_{i}}{{S}_{i , i + 1}} - \frac{{K}_{i}}{JS} & ( 2 )\end{matrix}$$

In the Expression (2), the speed of the vehicle traveling in the section Pᵢ, during a traffic congestion is represented by S_{i,i+1}. Here, S_{i,i+1} is represented, for example, by the average of an average speed Sᵢ of the vehicle in the direction from Pᵢ toward Pᵢ₊₁ obtained from the video image data of Pᵢ, and an average speed Sᵢ₊₁ of the vehicle in the direction from Pᵢ toward Pᵢ₊₁ obtained from the image data of Pᵢ₊₁. That is, S_{i,i+1} is expressed, for example, by the following Expression (3).

$$\begin{matrix}[ Expression 3 ] & \\ {S}_{i , i + 1} = \frac{{S}_{i} + {S}_{i + 1}}{2} & ( 3 )\end{matrix}$$

Note that in the Expression (2), although the traffic congestion speed JS is used as a reference speed that is used to calculate the loss time, other predetermined speeds, such as the legal speed of the road, may instead be used instead of JS.

Further, in the Expression (1), N represents the number of vehicles traveling in the section P_{i,i+1}, and corresponds to the number of vehicles that have caused the loss time. N is represented, for example, by the average of the number Qᵢ of vehicles in the direction from Pᵢ toward Pᵢ₊₁ obtained from the video image data of Pᵢ, and the number Qᵢ₊₁ of vehicles in the direction from Pᵢ toward Pᵢ₊₁ obtained from the image data of Pᵢ₊₁. That is, N is expressed, for example, by the following Expression (4).

$$\begin{matrix}[ Expression 4 ] & \\ N = \frac{{Q}_{i} + {Q}_{i + 1}}{2} & ( 4 )\end{matrix}$$

As shown in the Expression (1), the economic loss calculation unit 103 integrates the result obtained by multiplying the loss time Tₗₒₛₛ, the number N, the number JR of passengers, and the labor unit cost M for each time period JT during which a traffic congestion has occurred in a predetermined statistic acquisition period (e.g., one year). Further, the economic loss calculation unit 103 further integrates the result of the integration for a series of traffic-congested sections, that is, P_{1,2}, P_{2,3}, . . . P_{n-1,n}. In this way, the amount Z₁ of economic loss is calculated.

Note that although the economic loss calculation unit 103 may use a predetermined average value as the number JR of passengers in the Expression (1), this example embodiment can instead use statistical information about the number of passengers obtained by the analysis performed by the analysis unit 102. In this case, for example, the economic loss calculation unit 103 can use the value of the average number of passengers obtained by the analysis processing performed by the analysis unit 102 as a value of JR in the Expression (1). Note that the economic loss calculation unit 103 may use the value of the total number of passengers obtained by the analysis processing performed by the analysis unit 102 when the amount Z₁ of economic loss is calculated. In this case, the economic loss calculation unit 103 can use the value of the total number of passengers instead of N×JR in the Expression (1).

As described above, the economic loss calculation unit 103 may calculate the amount of economic loss by using statistical information about the number of passengers obtained from the video image data of the camera 200. By doing so, it is possible to calculate the amount of economic loss more accurately than when a predetermined value is used as the value of the number of passengers.

Note that the economic loss calculation unit 103 may calculate the amount of economic loss for each lane or each direction in which a vehicle travels (hereinafter referred to as a traveling direction). By doing so, it is possible to evaluate an effect of the traffic congestion on each lane or each traveling direction.

Next, the emission amount calculation unit 104 is described. In this example embodiment, the emission amount calculation unit 104 calculates, as an example, an amount (an amount of emissions of carbon dioxide) Z₂ of carbon dioxide that is excessively emitted due to a traffic congestion based on a loss time due to the traffic congestion, the number of vehicles that have caused the loss time, and the amount of carbon dioxide emitted from the vehicles. Specifically, the emission amount calculation unit 104 calculates the amount Z₂ of emissions of carbon dioxide, for example, by the following Expression (5).

$$\begin{matrix}[ Expression 5 ] & \\ {Z}_{2} = {\sum }_{{P}_{i , i + 1}} {\sum }_{J T} ( {T}_{l o s s} \times N \times {CO}_{2} ) & ( 5 )\end{matrix}$$

As shown in the Expression (5), the emission amount calculation unit 104 integrates the result obtained by multiplying the loss time Tₗₒₛₛ, the number N, and the amount CO₂ of emissions for each time period JT during which a traffic congestion has occurred in a predetermined statistical acquisition period (e.g., one year). Further, the emission amount calculation unit 104 further integrates the result of the integration for a series of traffic-congested sections, that is, P_{1,2}, P_{2,3}, . . . P_{n-1,n}. In this way, the amount Z₂ of emissions of carbon dioxide is calculated.

Note that although the emission amount calculation unit 104 may use a predetermined average value as the amount CO₂ of emissions in the Expression (5), this example embodiment can instead use the amount of emissions according to the statistical information about the type of vehicle obtained by the analysis performed by the analysis unit 102. Specifically, for example, the value of the average amount of emissions calculated from the ratios of each type of vehicle obtained by the analysis performed by the analysis unit 102 and the amount of emissions of carbon dioxide set in advance for each type of vehicle can be used as a value of CO₂ in the Expression (5). Note that when the amount Z₂ of emissions of carbon dioxide is calculated, in regard to the vehicles of which the types are specified by the analysis processing performed by the analysis unit 102, the emission amount calculation unit 104 may use an integrated value obtained by integrating the amount of emissions of carbon dioxide set in advance for each type of vehicle. In this case, the emission amount calculation unit 104 can use this integrated value instead of N×CO₂ in the Expression (5).

In this way, the emission amount calculation unit 104 may calculate an amount of emissions of a predetermined component by using the statistical information about the type of vehicle obtained from the video image data of the camera 200. By this configuration, it is possible to calculate an amount of a predetermined component that is excessively emitted due to a traffic congestion more accurately than when a uniform predetermined value is used as the amount emitted from one vehicle regardless of the type of vehicle.

Note that the emission amount calculation unit 104 may calculate the amount of emissions of carbon dioxide for each lane or each traveling direction. By doing so, it is possible to evaluate an effect of the traffic congestion on each lane or each traveling direction.

The cost acquisition unit 105 acquires information (hereinafter referred to as cost information) indicating the cost required for improving traffic infrastructure to eliminate a traffic congestion on the road for which a disadvantage is calculated by the economic loss calculation unit 103 and the emission amount calculation unit 104. The cost information is information about any cost required for improving traffic infrastructure related to the road. The cost information may be, for example, information about the number of improvements required to eliminate a traffic congestion, or information about the cost required for improving traffic infrastructure.

For example, the cost acquisition unit 105 may acquire the cost information by loading the cost information stored in a storage medium or acquire cost information transmitted by other apparatuses via a wired or wireless network. As described above, it is sufficient for the cost acquisition unit 105 to acquire cost information, and thus any method for acquiring cost information may be employed. Further, the cost information acquired by the cost acquisition unit 105 may be information input by a user, or may be information output from software that analyzes the cause of a traffic congestion based on the video image data of the camera 200 and outputs information about countermeasures against the traffic congestion according to the result of the analysis.

The determination unit 106 determines the degree of the need for an improvement in traffic infrastructure related to the road for which a disadvantage is calculated by the economic loss calculation unit 103 and the emission amount calculation unit 104. That is, the determination unit 106 determines the degree of the need for an improvement in traffic infrastructure to eliminate a traffic congestion on the road. Specifically, the determination unit 106 determines the degree of the need for an improvement in traffic infrastructure based on results of calculations performed by the economic loss calculation unit 103 and the emission amount calculation unit 104. For example, if the amount of economic loss calculated by the economic loss calculation unit 103 or the amount of emissions calculated by the emission amount calculation unit 104 exceeds a predetermined threshold, the determination unit 106 may determine that it is necessary to improve the traffic infrastructure.

Further, the determination unit 106 may further determine the degree of the need for an improvement in traffic infrastructure based on not only the results of the calculations performed by the economic loss calculation unit 103 and the emission amount calculation unit 104 but also another kind of information. The other kind of information may be, for example, statistical information generated by the analysis unit 102. Specifically, the statistical information used as the other kind of information may be information indicating at least one of a traffic-congested time of the road, a speed of the vehicle traveling on the road, and a waiting time of the vehicle at an intersection of the road. Further, the other kind of information may be the number of existing lanes of the road or the cost information acquired by the cost acquisition unit 105. Note that the information indicating the number of lanes may be extracted by the image analysis performed by the analysis unit 102 or may be information input by a user.

For example, the determination unit 106 may make the following determinations using the above-described evaluation items. Note that the determination method described below is merely an example, and the determination unit 106 may make a determination by another determination method using the above-described evaluation items. The determination unit 106 may weight each evaluation item and calculate a score for each road for which a disadvantage is calculated by the economic loss calculation unit 103 and the emission amount calculation unit 104. That is, the determination unit 106 may calculate a score, which is an index value indicating the degree of the need for an improvement in traffic infrastructure of the road, by calculating a weighted sum of the evaluation value of the evaluation item and a predetermined degree of importance of the evaluation item.

Note that for example, the evaluation value of each evaluation item has the following effects on the determination on the degree of the need for an improvement in traffic infrastructure. As the amount of the economic loss, the amount of emissions of carbon dioxide, the traffic-congested time, and the waiting time increases, the degree of need for an improvement in traffic infrastructure becomes higher. Further, regarding the number of lanes, it is considered that the more lanes the road has, the more important the road is, and thus the need for an improvement in traffic infrastructure becomes higher as the number of lanes increases. Regarding the speed of a vehicle and the cost required for improving traffic infrastructure, as the value becomes smaller, the degree of the need for an improvement in traffic infrastructure becomes higher. Note that not all of the above evaluation items may be used for determinations made by the determination unit 106, and instead only some of them may be used.

If the score exceeds a predetermined threshold, the determination unit 106 may determine that it is necessary to improve the traffic infrastructure. Further, the determination unit 106 may sort the roads requiring an improvement in traffic infrastructure in order of the score so as to prioritize the roads.

The output unit 107 outputs a result of the determination made by the determination unit 106. The output unit 107 may display the result of the determination as an output on a display or may transmit it to other apparatuses. Note that the information output by the output unit 107 is not limited to the result of the determination made by the determination unit 106, and may be other information pieces such as information generated by the analysis unit 102.

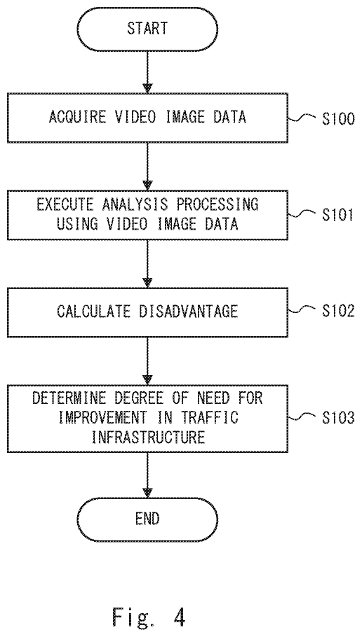

Next, an operation of the server 100 is described. FIG. 4 is a flowchart showing an example of the operation of the server 100. The example of the operation of the server 100 is described below with reference to FIG. 4.

In Step 100 (S100), the camera video image acquisition unit 101 acquires video image data from the camera 200.

Next, in Step 101 (S101), the analysis unit 102 executes predetermined analysis processing using the video image data acquired by the camera video image acquisition unit 101.

Next, in Step 102 (S102), the economic loss calculation unit 103 and the emission amount calculation unit 104 calculate a disadvantage due to a traffic congestion.

Next, in Step 103 (S103), the determination unit 106 determines the degree of the need for an improvement in traffic infrastructure based on the criterion for the determination including the disadvantage calculated in Step 102, and the output unit 107 outputs the result of the determination.

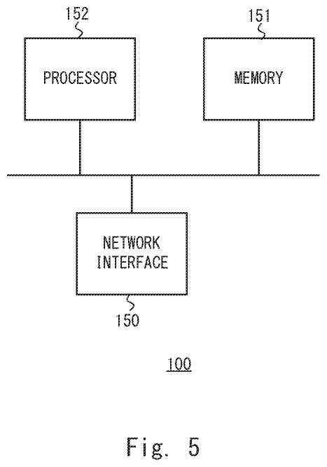

Next, an example of a hardware configuration of the server 100 is described. FIG. 5 is a block diagram showing the example of the hardware configuration of the server 100. As shown in FIG. 5, the server 100 includes, for example, a network interface 150, a memory 151, and a processor 152.

The network interface 150 is used to communicate with other apparatuses such as the camera 200. The network interface 150 may include, for example, a network interface card (NIC).

The memory 151 is composed of, for example, a combination of a volatile memory and a non-volatile memory. Note that the server 100 may include a storage device such as a hard disk in addition to the memory 151.

The memory 151 is used to store software (a computer program) including at least one instruction executed by the processor 152.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

The processor 152 loads the software (the computer program) from the memory 151 and executes the loaded software, thereby performing the above-described processing of the server 100. That is, the processing of each of the camera video image acquisition unit 101, the analysis unit 102, the economic loss calculation unit 103, the emission amount calculation unit 104, the cost acquisition unit 105, the determination unit 106, and the output unit 107 may be implemented by executing a program. As described above, the server 100 functions as a computer. The processor 152 may be, for example, a microprocessor, a Micro Processor Unit (MPU), or a Central Processing Unit (CPU). The processor 152 may include a plurality of processors.

Further, the server 100 may further include an input device such as a mouse and a keyboard, or an output device such as a display. Note that the server 100 may acquire information input to the server 100 from other apparatuses via a network, or may output information output from the server 100 to other apparatuses via a network.

The details of the example embodiment have been described above. In the information processing system 10, the amount of economic loss and the amount of emissions of carbon dioxide due to a traffic congestion of a road are calculated based on statistical information generated from video image data of the camera 200. Then, the determination unit 106 makes a determination using the result of the calculation. By this configuration, it is possible to easily grasp which of the roads to be monitored by the camera 200 should have their infrastructures improved.

Note that the present disclosure is not limited to the above-described example embodiment and can be modified as appropriate without departing from the spirit of the present disclosure.

Further, the whole or part of the example embodiment disclosed above can be described as, but not limited to, the following supplementary notes.

### (Supplementary Note 1)

An information processing apparatus comprising:

camera video image acquisition means for acquiring video image data from a camera configured to continuously shoot a traffic state of a predetermined road;

analysis means for generating statistical information about traffic on the road from the video image data acquired by the camera video image acquisition means; and

disadvantage calculation means for calculating a degree of a disadvantage caused by a traffic congestion on the road by using the statistical information generated by the analysis means.

### (Supplementary Note 2)

The information processing apparatus described in Supplementary Note 1, wherein the disadvantage calculation means calculates an amount of economic loss caused by the traffic congestion on the road as the degree of the disadvantage.

### (Supplementary Note 3)

The information processing apparatus described in Supplementary Note 2, wherein

the analysis means generates statistical information pieces including statistical information about the number of passengers of a vehicle traveling on the road from the video image data acquired by the camera video image acquisition means, and

the disadvantage calculation means calculates the amount of economic loss by using the statistical information about the number of passengers.

### (Supplementary Note 4)

The information processing apparatus described in any one of Supplementary Notes 1 to 3, wherein the disadvantage calculation means calculates an amount of emissions of a predetermined component of an exhaust gas emitted from a vehicle due to the traffic congestion on the road as the degree of the disadvantage.

### (Supplementary Note 5)

The information processing apparatus described in Supplementary Note 4, wherein

the analysis means generates statistical information pieces including statistical information about a type of the vehicle traveling on the road from the video image data acquired by the camera video image acquisition means, and

the disadvantage calculation means calculates the amount of emissions of the component by using the statistical information about the type of the vehicle.

### (Supplementary Note 6)

The information processing apparatus described in any one of Supplementary Notes 1 to 5, further comprising determination means for determining a degree of a need for an improvement in traffic infrastructure related to the road based on a result of the calculation performed by the disadvantage calculation means.

### (Supplementary Note 7)

The information processing apparatus described in Supplementary Note 6, wherein

the determination means further determines the degree of the need for an improvement in the traffic infrastructure related to the road based on the statistical information generated by the analysis means, and

the statistical information used for the determination made by the determination means is information indicating at least one of a traffic-congested time of the road, a speed of the vehicle traveling on the road, and a waiting time of the vehicle at an intersection of the road.

### (Supplementary Note 8)

The information processing apparatus described in Supplementary Note 6 or 7, wherein the determination means further determines the degree of the need for an improvement in the traffic infrastructure related to the road based on the number of existing lanes of the road.

### (Supplementary Note 9)

The information processing apparatus described in any one of Supplementary Notes 6 to 8, wherein the determination means further determines the degree of the need for an improvement in the traffic infrastructure based on a cost required for the improvement in the traffic infrastructure related to the road.

### (Supplementary Note 10)

A road analysis method comprising causing an information processing apparatus to:

acquire video image data from a camera configured to continuously shoot a traffic state of a predetermined road;

generate statistical information about traffic on the road from the acquired video image data; and

calculate a degree of a disadvantage caused by a traffic congestion on the road by using the statistical information.

### (Supplementary Note 11)

A non-transitory computer readable medium storing a program for causing a computer to execute:

a camera video image acquisition step of acquiring video image data from a camera configured to continuously shoot a traffic state of a predetermined road;

an analysis step of generating statistical information about traffic on the road from the video image data acquired in the camera video image acquisition step; and

a disadvantage calculation step of calculating a degree of a disadvantage caused by a traffic congestion on the road by using the statistical information generated in the analysis step.

While the present disclosure has been described with reference to the example embodiment, the present disclosure is not limited to the aforementioned example embodiment. Various changes that can be understood by those skilled in the art can be made to the configurations and the details of the present disclosure within the scope of the present disclosure.

This application is based upon and claims the benefit of priority from Japanese patent application No. 2018-066016, filed on Mar. 29, 2018, the disclosure of which is incorporated herein in its entirety by reference.

### REFERENCE SIGNS LIST

1 INFORMATION PROCESSING APPARATUS
2 CAMERA VIDEO IMAGE ACQUISITION UNIT
3 ANALYSIS UNIT
4 DISADVANTAGE CALCULATION UNIT
10 INFORMATION PROCESSING SYSTEM
100 SERVER
101 CAMERA VIDEO IMAGE ACQUISITION UNIT
102 ANALYSIS UNIT
103 ECONOMIC LOSS CALCULATION UNIT
104 EMISSION AMOUNT CALCULATION UNIT
105 COST ACQUISITION UNIT
106 DETERMINATION UNIT
107 OUTPUT UNIT
150 NETWORK INTERFACE
151 MEMORY
152 PROCESSOR
200 CAMERA

1. An information processing apparatus comprising:
at least one memory storing program instructions; and
at least one processor configured to execute the instructions stored in the memory to:
acquire video image data from a camera configured to continuously shoot a traffic state of a predetermined road;
generate statistical information about traffic on the road from the acquired video image data; and
calculate a degree of a disadvantage caused by a traffic congestion on the road by using the generated statistical information.

2. The information processing apparatus according to claim 1, wherein the processor is further configured to execute the instructions to calculate an amount of economic loss caused by the traffic congestion on the road as the degree of the disadvantage.

3. The information processing apparatus according to claim 2, wherein
the processor is further configured to execute the instructions to:
generate statistical information pieces including statistical information about the number of passengers of a vehicle traveling on the road from the acquired video image data, and
calculate the amount of economic loss by using the statistical information about the number of passengers.

4. The information processing apparatus according to claim 1, wherein the processor is further configured to execute the instructions to calculate an amount of emissions of a predetermined component of an exhaust gas emitted from a vehicle due to the traffic congestion on the road as the degree of the disadvantage.

5. The information processing apparatus according to claim 4, wherein
the processor is further configured to execute the instructions to:
generate statistical information pieces including statistical information about a type of the vehicle traveling on the road from the acquired video image data, and
calculate the amount of emissions of the component by using the statistical information about the type of the vehicle.

6. The information processing apparatus according to claim 1, wherein the processor is further configured to execute the instructions to determine a degree of a need for an improvement in traffic infrastructure related to the road based on a result of the calculation.

7. The information processing apparatus according to claim 6, wherein
the processor is further configured to execute the instructions to determine the degree of the need for an improvement in the traffic infrastructure related to the road based on the generated statistical information, and
the statistical information used for the determination is information indicating at least one of a traffic-congested time of the road, a speed of the vehicle traveling on the road, and a waiting time of the vehicle at an intersection of the road.

8. The information processing apparatus according to claim 6, wherein the processor is further configured to execute the instructions to determine the degree of the need for an improvement in the traffic infrastructure related to the road based on the number of existing lanes of the road.

9. The information processing apparatus according to claim 6, wherein the processor is further configured to execute the instructions to determine the degree of the need for an improvement in the traffic infrastructure based on a cost required for the improvement in the traffic infrastructure related to the road.

10. A road analysis method comprising causing an information processing apparatus to:
acquire video image data from a camera configured to continuously shoot a traffic state of a predetermined road;
generate statistical information about traffic on the road from the acquired video image data; and
calculate a degree of a disadvantage caused by a traffic congestion on the road by using the statistical information.

11. A non-transitory computer readable medium storing a program for causing a computer to execute:
a camera video image acquisition step of acquiring video image data from a camera configured to continuously shoot a traffic state of a predetermined road;
an analysis step of generating statistical information about traffic on the road from the video image data acquired in the camera video image acquisition step; and
a disadvantage calculation step of calculating a degree of a disadvantage caused by a traffic congestion on the road by using the statistical information generated in the analysis step.
